(19) United States
(12) Patent Application Publication
(10) Pub. No.: US 2015/0143435 A1
(43) Pub. Date: May 21, 2015

(54) SYSTEM AND METHOD FOR MANAGING MASHUP SERVICE BASED ON THE CONTENT OF MEDIA CONTENT

(71) Applicant: Electronics and Telecommunications Research Institute, Daejeon (KR)

(72) Inventors: HYUNG WOO KIM, Daejeon (KR); JOON MYUN CHO, Daejeon (KR); MYUNG EUN KIM, Daejeon (KR); MOO HUN LEE, Daejeon (KR); JEONG NAM YEOM, Daejeon (KR); JEONG JU YOO, Daejeon (KR); JIN WOO HONG, Daejeon (KR)

(21) Appl. No.: 14/524,843

(22) Filed: Oct. 27, 2014

(30) Foreign Application Priority Data
Nov. 21, 2013 (KR) 10-2013-0141887

(51) Int. Cl. H04N 21/258; H04N 21/44; H04N 21/434; H04N 21/234; H04N 21/45; H04N 21/236; H04N 21/235; H04N 21/81

(52) U.S. Cl. CPC H04N 21/25891; H04N 21/2353; H04N 21/44008; H04N 21/8133; H04N 21/23418; H04N 21/4532; H04N 21/23614; H04N 21/4348
USPC 725/86

(57) ABSTRACT

A system and method for managing a mashup service based on the content of media content are provided. The system and method infer tasks related to the content of media content that a user is currently viewing based on user profile information, and create and provide a personalized mashup service to execute a selected task, thereby overcoming restrictions and limitations in providing information in the existing content reproducing environment and improving user's viewing environment for media content.

### CROSS-REFERENCE TO RELATED APPLICATION(S)

This application claims priority from Korean Patent Application No. 10-2013-0141887, filed on Nov. 21, 2013, in the Korean Intellectual Property Office, the disclosure of which is incorporated herein by reference in its entirety.

### BACKGROUND

1. Field

The following description relates to a mashup service, and more particularly, to a system and method for managing a mashup service based on the content of media content.

2. Description of the Related Art

With the convergence of broadcasting and communications infrastructure, a television has been evolving from a passive device, which only delivers broadcast content from a broadcasting station to viewers, to a more interactive, smart device allowing for Internet full-browsing and execution of various applications thereon.

With the traditional TVs as “lean-back” media devices, viewers may watch video content at fixed hours, which are broadcast from terrestrial broadcasting stations. Meanwhile, change in consumption pattern of such video content takes place by virtue of combination of TV and Internet. Users have more actively interacted with smart devices, regarded as “lean-forward” media, to search for any content desired, as well as terrestrial broadcast content, at anytime and anywhere through the Internet.

As the user's passive attitude toward TV has changed to an active attitude, desires for content-related information, for example, a person, a place, products, and the like, which are seen in the currently played content, are increasing.

Various researches on techniques for providing content-related information have been conducted. For example, Korean Patent Registration No. 10-1175708 (registered on Aug. 14, 2012) discloses “System and method for providing information through moving picture executed on a smart device and thereof,” wherein information about persons or products included in a moving picture is provided. Such technologies, yet, simply provide information only by showing information about a person, a place, products, or the like, which are seen in the moving picture.

Therefore, there is a need for technology applicable to a smart TV environment and various user devices, such as smart pads, smart phones and other smart devices, which identify the user's preferences and characteristics, create user-tailored information based on the identified user information, and further support tasks and related services that are appropriate for additional information of the media content, rather than simply provide the information.

### SUMMARY

In one general aspect, there is provided a system for managing a mashup service based on a content of media content, wherein the system collects meta information from a broadcasting network or Internet wherein the meta information is related to the content of media content that is currently played on a user terminal which issues a request for a mashup service recommendation; creates a mashup service that conforms to a user's situation and the content of the media content, based on additional information analyzed from the collected meta information; and provides the mashup service to the user terminal.

The system may include a task inferer component configured to search a user profile database (DB) for a user profile associated with the user terminal that issues the request for mashup service recommendation and to infer tasks based on the found user profile wherein the inferred tasks correspond to additional information selected from the media content played on the user terminal and are appropriate for a user of the user terminal; and a mashup service creator component configured to search a unit service module DB for unit service modules to execute a task selected from among the inferred tasks, and to create a personalized mashup service by combining the found unit service modules.

The system may further include a mashup service recommender component configured to provide the personalized mashup service created by the mashup service creator component to the user terminal that issues the request for mashup service recommendation.

The system may further include a profile manager component configured to store the user profiles in the user profile DB and manage the user profiles; a unit service module manager component configured to store unit service modules that are used to create a mashup service in the unit service module DB, and manage the unit service modules; a mashup service recommendation request component configured to receive the request for mashup service recommendation from the user terminal; and a content analyzer component configured to analyze the content of the media content played on the user terminal in response to a request for additional information from the user terminal.

The content analyzer may be configured to, in response to the request for additional information from the user terminal, search for additional information contained in the media content played on the user terminal by analyzing the content of the media content.

The system may further include an additional information manager component configured to store, in an additional information DB, the additional information, which is contained in the media content, in a form of annotation files that contain semantic content and to manage the additional information.

The content analyzer component may be configured to search the additional information DB for the additional information contained in the media content played on the user terminal.

The system may further include an additional information tag display component configured to display the additional information found by the content analyzer component as the additional information tags on the media content played on the user terminal.

The mashup service recommendation request component may be configured to, in response to user's selection of a particular additional information tag from among the additional information tags displayed on the media content played on the user terminal, receive the request for mashup service recommendation from the user terminal.

The task inferer component may be configured to infer the tasks appropriate for the user by taking into account at least one of user's age, sex, home range, usage history of media content, which are contained in the user profile.

In another general aspect, there is provided a method of a system for managing a mashup service based on a content of media content, the method including: receiving a request for mashup service recommendation from a user terminal that is currently playing the media content; searching for a user profile associated with the user terminal that issues the request for mashup service recommendation, and inferring tasks based on the found user profile wherein the inferred tasks correspond to additional information selected from the media content played on the user terminal and are appropriate for a user of the user terminal; and searching for unit service modules to execute a task selected from among the inferred tasks, and creating a personalized mashup service by combining the found unit service modules.

The method may further include providing the created personalized mashup service to the user terminal that issues the request for mashup service recommendation.

The method may further include receiving a request for additional information contained in the currently played media content from the user terminal; analyzing the content of the media content played on the user terminal and searching for the additional information contained in the media content; and displaying the found additional information as additional information tags on the media content played on the user terminal.

The receiving of the request for mashup service recommendation may include, in response to user's selection of a particular additional information tag from among the additional information tags displayed on the media content played on the user terminal, receiving the request for mashup service recommendation from the user terminal.

The inferring of the tasks may include inferring the tasks appropriate for the user by taking into account at least one of user's age, sex, home range, usage history of media content, which are contained in the user profile.

Other features and aspects will be apparent from the following detailed description, the drawings, and the claims.

### BRIEF DESCRIPTION OF THE DRAWINGS

FIG. 1 is a block diagram illustrating a system for managing a mashup service based on the content of media content according to an exemplary embodiment.

FIG. 2 is a diagram illustrating an example of a display screen of the content-based mashup service management system of FIG. 1 which shows additional information tags, according to an exemplary embodiment.

FIG. 3 is a diagram illustrating an example of a display screen of the content-based mashup service management system of FIG. 1 to allow a user to select a task.

FIG. 4 is a diagram illustrating an example of a display screen of the content-based mashup service management system of FIG. 1 which shows mashup service recommendations.

FIG. 5 is a flowchart illustrating a method of managing a content-based mashup service according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Exemplary embodiments will now be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

Throughout the drawings and the detailed description, unless otherwise described, the same drawing reference numerals are understood to refer to the same elements, features, and structures. The relative size and depiction of these elements may be exaggerated for clarity, illustration, and convenience.

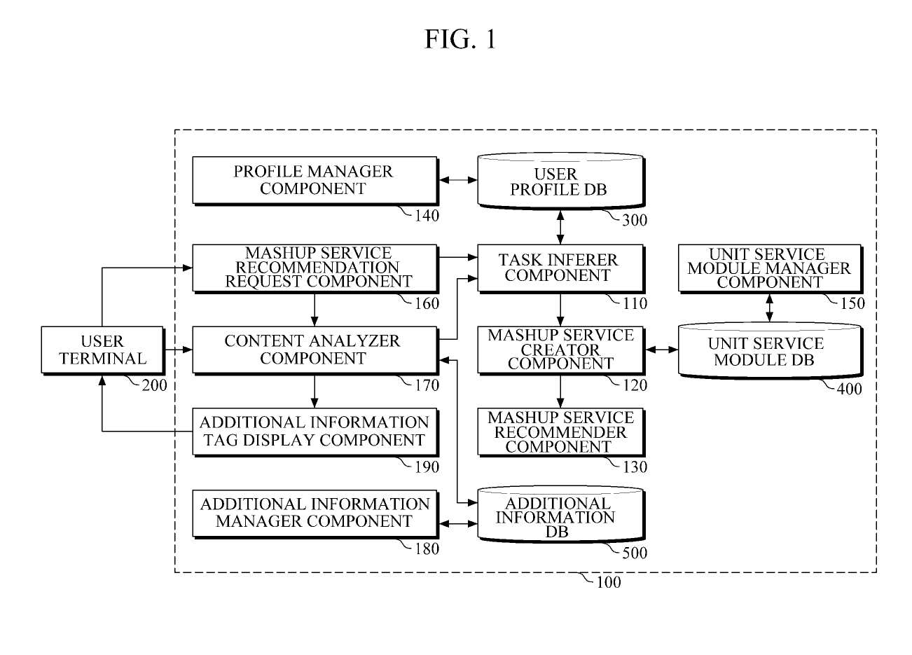

FIG. 1 is a block diagram illustrating a system for managing a mashup service based on the content of media content according to an exemplary embodiment. The system 100 for managing a mashup service based on the content of media content may collect meta information from a broadcasting network or the Internet, wherein the meta information is related to the content of media content that is played in a user terminal 200 that requests mashup service recommendation. Also, the system 100 may create a mashup service that conforms to a user's situation and the content of the media content, and provide the mashup service to the user terminal 200.

Referring to FIG. 1, the system 100 includes a task inferer component 110 and a mashup service creator component 120.

The task inferer component 110 may search for user profile from a user profile DB 300, where the user profile is associated with the user terminal 200 that requests the mashup service recommendation, and, based on the found user profile, infer tasks that are related to additional information selected from the media content played on the user terminal and that are appropriate for the user of the terminal 200.

In this case, the user terminal 200 may be a device, such as, TV or a smartphone, which is capable of playing media content and is equipped with network functions. The user profiles present in the user profile DB 300 may include information about users, such as their age, sex, home range, usage history of media content, and the like. The user profiles may be previously obtained when users subscribe to content-based mashup services, or through a data mining mechanism, and may then be stored in the user profile DB 300. In addition, the user profiles may be stored in the user profile DB 300 after being matched with user terminal identification numbers or user IDs. Accordingly, the user profiles may be identified by means of the user terminal identification numbers or the user IDs.

For example, the task inferer component 110 may infer tasks appropriate for the requesting user by taking into account at least one of user's age, sex, home range, and usage history of media content, which are contained in the user profile.

Here, the task refers to information that define jobs to be executed in relation to additional information, such as persons, places, products, and the like, which are contained in media content, and at least one task may be selected for each user, depending on the user profile.

The mashup service creator component 120 may search a unit service module DB 400 for unit service modules that are to execute a task selected among the tasks inferred by the task inferer component 110, and combine the found unit service modules to create a customized mashup service.

The unit service modules are individual software modules that independently process tasks which are information defining the jobs to be executed in relation to the additional information, such as persons, places, products, and the like, which are contained in media content. The mashup service is information personalized to each user, which is generated by selecting the unit service modules according to the user profile and combining the selected unit service modules.

Accordingly, it may be possible to infer tasks related to media content currently viewed by the user, based on the user profile information, and to create a mashup service for executing the inferred task.

In another example, the system 100 may further include a mashup service recommender component 130. The mashup service recommender component 130 may provide the personalized mashup service created by the mashup service creator component 120 to the user terminal 200 that has requested the mashup service recommendation.

Therefore, it may be possible to infer tasks related to the content of the media content currently being used by the user, based on the user profile information, and to create the mashup service to execute the tasks and provide the mashup service to the user. As a result, restrictions and limitations in providing information in the existing content reproducing environment may be overcome and the user's viewing environment for media content can be improved.

In another aspect, the system 100 may further include a profile manager component 140, a unit service module manager component 150, a mashup service recommendation request component 160, and a content analyzer component 170.

The profile manager component 140 may store the user profiles in the user profile DB 300 and manage them. The user profiles may include information about users, such as age, sex, home range, usage history of media content, and the like. The profile manager component 140 may obtain the information about users, such as their age, sex, and home range, during the content-based mashup service subscription process, and may obtain the information, such as the users' usage history of media content, by collecting and analyzing records of use of the media content using a data mining mechanism. The profile manager component 140 may store the obtained information in the user profile DB 300 and manage it. The user profiles managed by the profile manager component 140 are used when the task inferer component 110 infers relevant tasks.

The unit service module manager component 150 may store the unit service modules, which are used to create a mashup service, in the unit service module DB 400 and manage them. The unit service modules are individual software modules that independently process tasks that are information defining jobs to be executed in relation to additional information, such as, a person, a place, products, and the like. For example, the unit service modules may be registered in or removed from the unit service module DB 400 by the unit service module manager component 150. Also, the unit service modules managed by the unit service module manager component 150 may be used when the mashup service creator component 120 creates a mashup service.

The mashup service recommendation request component 160 may receive a request for mashup service recommendation from the user terminal 200. For example, the mashup service recommendation request component 160 may receive a mashup service recommendation request in response to the user's selection of a particular additional information tag from among all additional information tags displayed on the media content that is currently being played on the user terminal 200. The additional information tags will be described later in detail.

The content analyzer component 170 may analyze the content of the media content currently being played on the user terminal 200, according to a request for additional information from the user terminal 200. For example, in response to the request for additional information from the user terminal 200, the content analyzer component 170 may analyze the content of the media content currently being played on the user terminal 200 to search for additional information contained in the played media content. The content of media content analyzed by the content analyzer component 170 is used when the task inferer component 110 inters a task.

In another aspect, the system 100 may further include an additional information manager component 180. The additional information manager component 180 may store the additional information, which is contained in the media content, in the additional information DB 500 in the form of annotation files that contain semantic content.

In this case, the content analyzer component 170 may search the additional information DB 500 for additional information contained in the media content currently being played on the user terminal. For example, the content analyzer component 170 may extract keywords related to the additional information from meta information of content data, and may search for the additional information from the additional information DB 500 through semantic-based retrieval using the extracted keywords.

In another aspect, the system 100 may further include an additional information tag display component 190. The additional information tag display component 190 displays the additional information found by the content analyzer component 170 as additional information tags on the media content played on the user terminal 200.

The additional information may include information about a person, place, and products contained in the media content currently being played on the user terminal 200, and the additional information tags may be provided to enable the additional information to be, respectively, visually identified on the media content played on the user terminal 200.

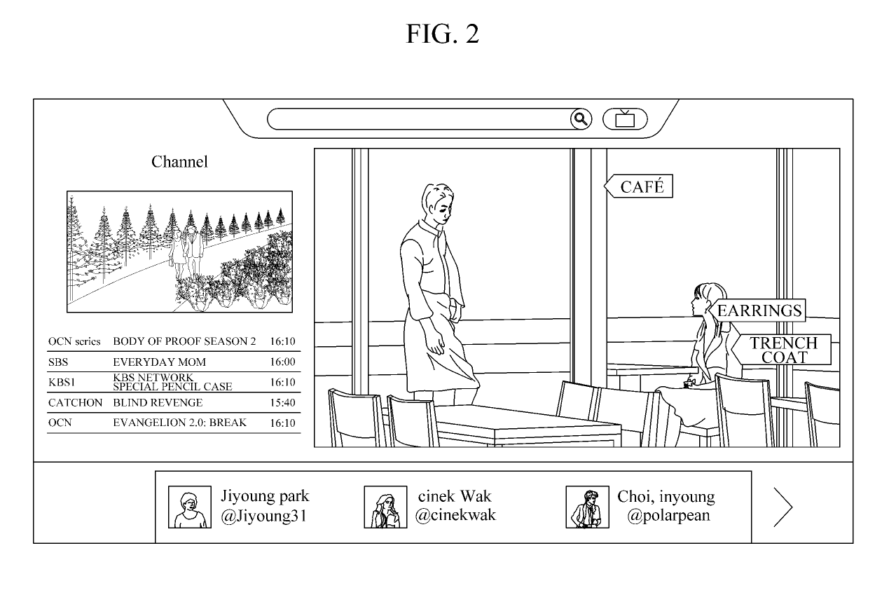

FIG. 2 is a diagram illustrating an example of a display screen of the content-based mashup service management system of FIG. 1 which shows additional information tags, according to an exemplary embodiment. Referring to FIG. 2, additional information tags, such as, “café,” “earrings,” and “trench coat,” are seen in a broadcast content played on the user terminal 200.

In this case, in response to the user's selection of a particular additional information tag from among all additional information tags seen on the media content played on the user terminal 200, the mashup service recommendation request component 160 may receive a request for mashup service recommendation from the user terminal 200.

For example, if the user selects additional information tag “Café,” the mashup service recommendation request component 160 may receive a request for mashup service recommendation related to “café.”

Then, the task inferer component 110 may infer tasks related to “café” based on the corresponding user profile, and receive a user's selection of a particular task for recommendation, from a list of the inferred tasks that is provided to the user terminal 200.

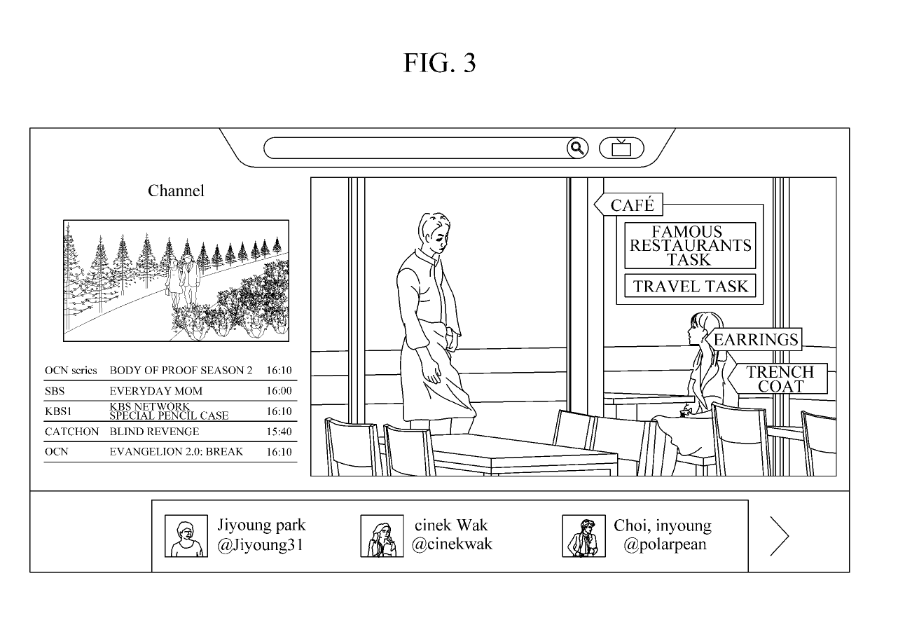

FIG. 3 is a diagram illustrating an example of a display screen of the content-based mashup service management system of FIG. 1 to allow a user to select a task. Referring to FIG. 3, “famous restaurants task” and “travel task” that are tasks inferred in response to the user's selection of the additional information tag, “café,” are displayed on the user terminal 200.

In response to the user's selection of “travel task” on the display, the mashup service creator component 120 searches for unit service modules to execute the selected “travel task,” creates a personalized mashup service by combining the found unit service modules, and provides the created personalized mashup service to the user terminal 200 through the mashup service recommender component 130.

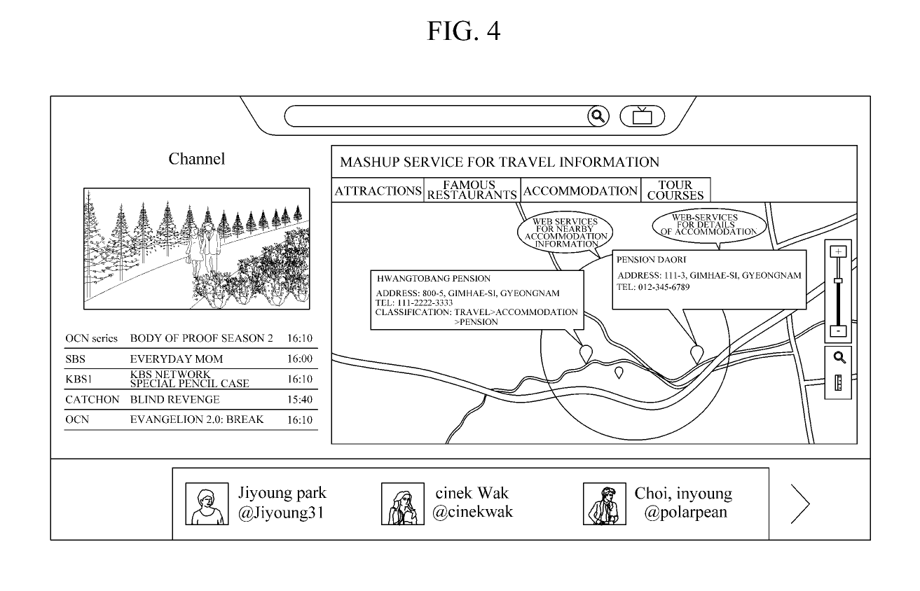

FIG. 4 is a diagram illustrating an example of a display screen of the content-based mashup service management system of FIG. 1 which shows mashup service recommendations. Referring to FIG. 4, a personalized mashup service that is created by combining unit service modules, “attractions,” “famous restaurants,” “accommodation” and “tour courses” is provided to the user terminal 200.

As such, through the system as described above, it is possible to infer the tasks related to the media content that the user is currently watching, based on the user profile information, and to create a mashup service for executing the task and then provide the created mashup service to the user terminal, so that restrictions and limitations in providing information in the existing content reproducing environment may be overcome and the user's viewing environment for media content can be improved.

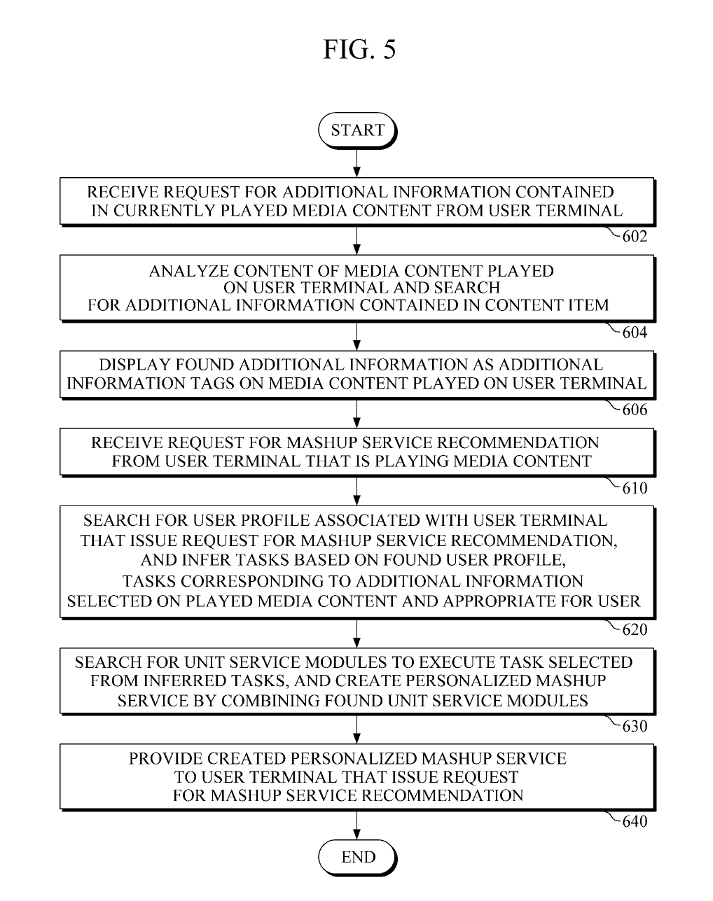

A method of managing a content-based mashup service in the content-based mashup service management system as described above will be described with reference to FIG. 5. FIG. 5 is a flowchart illustrating a method of managing a content-based mashup service according to an exemplary embodiment of the present invention.

First, in 610, a system for managing a mashup service based on the content of media content receives a request for mashup service recommendation from a user terminal that currently plays the media content.

In 610, in response to the user's selection of a particular additional information tag from among additional information tags displayed on the media content currently played on the user terminal, the system may receive the request for mashup service recommendation from the user terminal.

Thereafter, in 620, the system searches for user profile associated with the user terminal that requests the mashup service recommendation, and infers tasks that are related to additional information selected from the media content played on the user terminal and also are appropriate for the user of the terminal.

In 620, the system may infer the tasks appropriate for the user by taking into account at least one of user's age, sex, home range, and usage history of media content, which are contained in the user profile.

Then, in 630, the system searches for unit service modules for executing a task selected from among the tasks inferred in 620, and creates a personalized mashup service by combining the found unit service modules.

Accordingly, it is possible to infer tasks related to the content of the media content that the user is viewing, based on the user profile information, and to create a mashup service to execute the inferred task.

In another aspect, the method of managing a mashup service based on the content of media content may further include an operation 640 of recommendation of a mashup service. In 640, the system provides the personalized mashup service created in 630 to the user terminal that has requested the mashup service recommendation.

Accordingly, by inferring tasks related to the content of the media content that the user is viewing, based on the user profile information and creating a mashup service to execute the inferred task, it may be possible to enhance the user's viewing environment for the media content.

In another aspect, the method may further include operations 602, 604, and 605 of receiving request for additional information, searching for additional information, and displaying additional information tags.

In 602, the system receives a request for additional information contained in the media content from the user terminal that is playing the media content. The request for additional information is described above, and thus the detailed description thereof will not be reiterated.

In 604, the system analyzes the content of the media content played on the user terminal, and searches for the additional information contained in the media content. The search for additional information is described above, and thus the detailed description thereof will not be reiterated.

In 606, the system displays the found additional information using additional information tags on the media content reproduced on the user terminal. The displaying of the additional information tags is described above, and thus the detailed description thereof will not be reiterated.

Thereafter, in response to the user's selection of a particular additional information tag from among the additional tags seen in the media content displayed on the user terminal 200, the system receives a request for mashup service recommendation from the user terminal in 610.

Then, in 620, the system infers tasks related to the selected particular additional information tag. In response to the user's selection of a specific task from among the inferred tasks to receive recommendation of a relevant mashup service, in 630, the system searches for unit service modules to execute the selected task, and then creates a personalized mashup service by combining the found unit service modules. In 640, the system provides the created personalized mashup service to the user terminal.

As such, the system can infer tasks related to the content of media content that the user is currently viewing, based on the user profile information, and creates and provides a personalized mashup service, thereby overcoming the restrictions and limitations in providing information in the existing content reproducing environment and enhancing the user's viewing environment for the media content.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for managing a mashup service based on a content of media content, wherein the system collects meta information from a broadcasting network or Internet wherein the meta information is related to the content of media content that is currently played on a user terminal which issues a request for a mashup service recommendation; creates a mashup service that conforms to a user's situation and the content of the media content, based on additional information analyzed from the collected meta information; and provides the mashup service to the user terminal.

2. The system of claim 1, comprising:
a task inferer component configured to search a user profile database (DB) for a user profile associated with the user terminal that issues the request for mashup service recommendation and to infer tasks based on the found user profile wherein the inferred tasks correspond to additional information selected from the media content played on the user terminal and are appropriate for a user of the user terminal; and
a mashup service creator component configured to search a unit service module DB for unit service modules to execute a task selected from among the inferred tasks, and to create a personalized mashup service by combining the found unit service modules.

3. The system of claim 2, further comprising:
a mashup service recommender component configured to provide the personalized mashup service created by the mashup service creator component to the user terminal that issues the request for mashup service recommendation.

4. The system of claim 2, further comprising:
a profile manager component configured to store the user profiles in the user profile DB and manage the user profiles;
a unit service module manager component configured to store unit service modules that are used to create a mashup service in the unit service module DB, and manage the unit service modules;
a mashup service recommendation request component configured to receive the request for mashup service recommendation from the user terminal; and
a content analyzer component configured to analyze the content of the media content played on the user terminal in response to a request for additional information from the user terminal.

5. The system of claim 4, wherein the content analyzer is configured to, in response to the request for additional information from the user terminal, search for additional information contained in the media content played on the user terminal by analyzing the content of the media content.

6. The system of claim 5, further comprising:
an additional information manager component configured to store, the additional information, which is contained in the media content, in an additional information DB in a form of annotation files that contain semantic content and to manage the additional information.

7. The system of claim 6, wherein the content analyzer component is configured to search the additional information DB for the additional information contained in the media content played on the user terminal.

8. The system of claim 5, further comprising:
an additional information tag display component configured to display the additional information found by the content analyzer component as the additional information tags on the media content played on the user terminal.

9. The system of claim 8, wherein the mashup service recommendation request component is configured to, in response to user's selection of a particular additional information tag from among the additional information tags displayed on the media content played on the user terminal, receive the request for mashup service recommendation from the user terminal.

10. The system of claim 2, wherein the task inferer component is configured to infer the tasks appropriate for the user by taking into account at least one of user's age, sex, home range, usage history of media content which are contained in the user profile.

11. A method of a system for managing a mashup service based on a content of media content, the method comprising:
receiving a request for mashup service recommendation from a user terminal that is currently playing the media content;
searching for a user profile associated with the user terminal that issues the request for mashup service recommendation, and inferring tasks based on the found user profile wherein the inferred tasks correspond to additional information selected from the media content played on the user terminal and are appropriate for a user of the user terminal; and
searching for unit service modules to execute a task selected from among the inferred tasks, and creating a personalized mashup service by combining the found unit service modules.

12. The method of claim 11, further comprising:
providing the created personalized mashup service to the user terminal that issues the request for mashup service recommendation.

13. The method of claim 11, further comprising:
receiving a request for additional information contained in the currently played media content from the user terminal;
analyzing the content of the media content played on the user terminal and searching for the additional information contained in the media content; and
displaying the found additional information as additional information tags on the media content played on the user terminal.

14. The method of claim 13, wherein the receiving of the request for mashup service recommendation comprises, in response to user's selection of a particular additional information tag from among the additional information tags displayed on the media content played on the user terminal, receiving the request for mashup service recommendation from the user terminal.

15. The method of claim 11, wherein the inferring of the tasks comprises inferring the tasks appropriate for the user by taking into account at least one of user's age, sex, home range, usage history of media content which are contained in the user profile.
